(19) United States
(12) Patent Application Publication
(10) Pub. No.: US 2021/0084150 A1
(43) Pub. Date: Mar. 18, 2021

(54) System and Method for Providing In-Call Display

(71) Applicant: Daniel Nagy, Anaheim, CA (US)

(72) Inventor: Daniel Nagy, Anaheim, CA (US)

(21) Appl. No.: 16/571,195

(22) Filed: Sep. 16, 2019

(51) Int. Cl. H04M 3/51; H04M 1/725; G06Q 20/16

(52) U.S. Cl. CPC H04M 3/5166; H04M 3/5183; G06Q 20/16; H04M 1/72583; H04M 1/72525

(57) ABSTRACT

The present disclosure discloses a system and method for in-call display interface to see visual media during a connected phone call. A request to display in-call information is received, and in response to the request the in-call information regarding the visual media is displayed during active phone calls besides making payments during a phone call by either manual or saved payment methods.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Present Disclosure

The present disclosure relates generally to the field of communications. More particularly, this present disclosure relates to a system and method for in-call display interface to see visual media during a connected phone call. In-addition the app covers making payments and transacting during a phone call by either manual or saved payment methods during active phone calls.

### Description of the Related Art

When a user places a phone call to a call center, the phone call may be answered by an auto-attendant of the call center. Interactive Voice Response (IVR) and auto attendants, otherwise known as automated telephone answering systems, have been known for many years. Their primary purpose is to automatically direct calls received by a company to the most appropriate location within the company. The Interactive Voice Response IVR or auto attendant prompts callers to make numerical or voice selections corresponding to the department or person to which they want to be connected. This reduces the number of human operators or receptionists that are needed, providing substantial cost savings for the company.

The IVR or auto-attendant is an automated system that recites, over the phone to the user, a list of options along with respectively-associated keypad numbers (e.g., “Press 1 for customer service, 2 for billing”). The user selects a desired one of the listed options by saying a voice command or pressing the number on the keypad that is associated with the desired option. The IVR or auto-attendant then routes the call to an agent of the call center that is associated with the selected option.

Conventional systems, taken either individually or in combination, does not teach the present disclosure as claimed. Hence, the inventor of the present disclosure proposes to resolve and surmount existent technical difficulties to eliminate the aforementioned shortcomings of the prior art.

### SUMMARY

In light of the disadvantages of the prior art, the following summary is provided to facilitate an understanding of some of the innovative features unique to the present disclosure and is not intended to be a full description. A full appreciation of the various aspects of the present disclosure can be gained by taking the entire specification, claims, drawings, and abstract as a whole.

The app allows users to see visual media during a connected phone call. Specifically, during a connected phone call,

1. app allows users to share digital content, including but not limited to images, video, data, marketing, social media, games, etc.
2. app allows users to transact. The user can make a payment in exchange for services or goods bilaterally (between two people) or unilaterally (between a person and an automated system). The users can also share financial currencies.

Another object of the present disclosure is that anyone who has access to the proposed app or an app that is integrated with the dialer database.

An additional object of the present disclosure is to show visual content that is displayed to any user enabled with the proposed app (or integrated) on their smartphone, or any digital display that could project digital content. The data and resultant visual media are all stored, routed, shared, and transferred from and to the database.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed subject matter of the present disclosure, and explain various principles and advantages of those embodiments.

FIG. 1 is a block diagram of an example system for providing a smart phone interface for enhancing a call center's IVR or auto-attendant, in accordance with the subject matter of the present disclosure.

FIG. 2 is a flow chart of an example method performed by the system, in accordance with the subject matter of the present disclosure.

FIG. 3 shows Placing of a phone call to HOME DEPOT®.

FIG. 4 shows Connecting a phone call which system recognizes that the phone call will be answered by the auto-attendant that will recite audio options list.

FIG. 5 shows displaying a textual option list corresponding to the audio option list.

FIG. 6 shows display of textual option list corresponding to the audio option list.

FIG. 7 shows user enters/finds phone number to the restaurant.

FIG. 8 is a call connecting to the restaurant.

FIG. 9 is a call is answered by the restaurant agent (human).

FIG. 10 shows user verbally tells the restaurant agent (human) the rest of his order.

FIG. 11 shows the “Checkout” link at the bottom of the page, representing a request for payment.

FIG. 12 shows user is paying for the order. The user can choose a stored payment method or enter a manual payment method.

FIG. 13 shows the user sees that his payment is confirmed and the order has been paid for.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the subject matter of the present disclosure may be embodied in various forms. Therefore, specific details disclosed herein are not to be interpreted as limiting, but rather as a basis for the claims and as a representative basis for teaching one skilled in the art to employ subject matter of the present disclosure in virtually any appropriately detailed system, structure or manner.

FIG. 1 is a block diagram of an example system for providing a smart phone interface for enhancing a call center's auto-attendant. The system includes a call center 1 configured to receive an incoming phone call from a smart phone. The call center has different agents for performing respectively different types of functions for respectively different types of purposes of the incoming call.

As per one embodiment of the present disclosure, the call center communicates with a smart phone through a front end communication channel FE (front channel). The front channel includes a server 2 of the call-center, that is in communication, through a cellular and/or VOIP network 3, with a smart phone 4 of a user. When the user places a phone call to the call center, the call center server picks up the call and plays an auto-attendant message, which may be a prerecorded audio message that prompts the user to select a desired option (e.g., purpose of the call) using keys of the smart phone's telephone keypad. The auto-attendant's audio message might recite a list of options (option list), representing possible purposes of the call, along with associated keypad numbers (e.g., “Press 1 for customer service, 2 for billing, 3 for package-tracking”) The user selects the desired option by selecting (touching) the number (on the keypad) that corresponds to the desired option. The call center's server receives the user's key selection, possibly through DTMF tones, which indicates the user's selected option. The call center's server routes the call to the agent, of the call center, that is associated with the selected option.

The IVR's audio message might recite a list of options (option list), representing possible purposes of the call, along with associated key words (e.g., “Say Billing or press 1” or “Say Customer Service or press 2.”) The user selects the desired option by saying the key words (speaking) or selecting (touching) the number (on the keypad) that corresponds to the desired option. The call center's server receives the user's verbal selection, or key selection, possibly through DTMF tones, which indicates the user's selected option. The call center's server routes the call to the agent, of the call center, that is associated with the selected option.

Installed on the smart phone is a software application (app) for enhancing the IVR or audio auto-attendant message by displaying text that corresponds to the IVR or auto-attendant message. The app is in communication with a database server 5 that includes a database 6. The database stores a list of phone numbers of call centers. The database further stores, for each of the call centers, the options list of the respective call center's auto-attendant. When the call is being placed by the user, the app sends an indication of the dialed phone number to the database server. If the dialed phone number matches one of the call center phone numbers in the database, the database server sends, to the app, the matching call center's IVR or auto-attendant option list. When the IVR or auto-attendant recites the audio message containing the option list over the phone to the user, the app displays, on the phone's screen to the user, text corresponding to the option list.

The user may select from the option list displayed on the app by touching the visual list or verbalizing (saying) the selected option from the visual list. The user's selection is sent to the call center's server through the front-end channel which prompts the auto attendant or IVR to respond with the next step in the programmed option list. In parallel, the user's selection from the visual option displayed in the app is also sent to the database. Each time the user makes a selection from the visual option list displayed in the app, the app sends the selection to the database, which is captured by the database, then the database server sends the next step in the programmed option list to the app for display on the phone to the user.

The user may make their selection by pushing the visual option or saying the key words displayed in the visual option. The user may also communicate with the call center server in other methods like biometric recognition (e.g. voice imprint recognition or fingerprint verification) or movement recognition (e.g. hand wave or blinking). Alternatively, the user can communicate with the call center's server through the back channel (via the database server).

The textual option list might be completely displayed before the audio option list is completely recited. This enables the user to understand all the options and select the desired option even before that option has been verbally recited by the IVR or auto-attendant. Additionally, the user might consider reading the option list to be simpler to do than listening to the option list. The user may select from the visual option list before, during, or after that option has been verbally recited by the IVR or auto-attendant.

As explained above, data in the database includes each call center's phone number and option list. This data might be obtained by a person (1) looking up phone numbers of different call centers, (2) calling each call center and manually recording the respective call center's option list, and then (3) manually entering the call center's name, phone number, and option list into the database. The person might periodically (e.g., monthly) phone the call center again to check for any updates (changes) that the call center might have made to the option list.

The data in the database might further include, for each call center's auto-attendant, an indication of amount of time (how long to wait) before a key selection may be entered (for that key entry to be recognized by the auto-attendant), so that the app will postpone displaying the waitlist for that amount of time.

In another example, the database server and the call center's server might be mutually configured (programmed) to communicate with each other through a back-end communication channel BE (back channel). The back channel might be implemented through API (Application Programming Interface). In that case, at least some of the data (call center phone numbers and option lists) in the database might be obtained from the call center's server itself via the back channel. This obviates the need for the option list and subsequent option-list updates to be manually recorded and entered into the database.

In another example, the vendor's server and the app are mutually configured (programmed) to communicate with each other by embedding data through the front channel, in the form of data signals that are embedded within the cellular and/or VOIP signal but that are imperceptible to the user. In this example, the option list can be communicated by the call center's server to the app through the front end cellular and/or VOIP signal. This obviates the need for the option list and subsequent updates to be manually recorded and entered into the database.

In another example, the vendor may choose to use the database to store the option list and the auto-attendant's audio message and the backend server would deliver both.

Before or after the user selects the option, or while the user is on hold waiting to be connected to the agent (of the call center), the call center's server can send, to the app for display on the phone's screen, additional text (e.g., advertisements). The additional text can be communicated by the call center's server to the app through the front channel, in the form of signals that are embedded within the cellular and/or VOIP signal but that are imperceptible to the user. Alternatively, the additional text can be communicated by the call center's server to the app through the back channel (via the database server). The call center may add said additional text to the database manually or via computer automation. The call center agent may queue the call center server's server for the additional text, which is then sent to the database to retrieve the specific text requested, which is then received by the database and then delivered by the database server to the app for display on the phone screen.

The app displays a custom interface that may be in sync with the auto attendant. The database might store identities of companies and might display their auto-suggest logic. The logic might be programmed into the database and run the interface on the user's phone. The interface might match the current menu options made available by the auto attendant. This might include read-only business-to-customer (B2C) content with a simple message window. The window might display a receipt of purchase the user just completed with the auto attendant, or a summary of issues that the customer service operator (agent) discussed with the user. The interface might facilitate marketing, for example with promotions or coupons that may appear while the user is on an active call. The interface might facilitate transactions and/or ecommerce for any purchase or transaction that may take place on the custom dial pad. The interface might take a survey from the user. The interface might present recorded videos and tutorials. The interface might be displayed forms and enable the user to fill out the forms. The interface might be used with augmented reality, for example if the dial pad is hovering in front of the user.

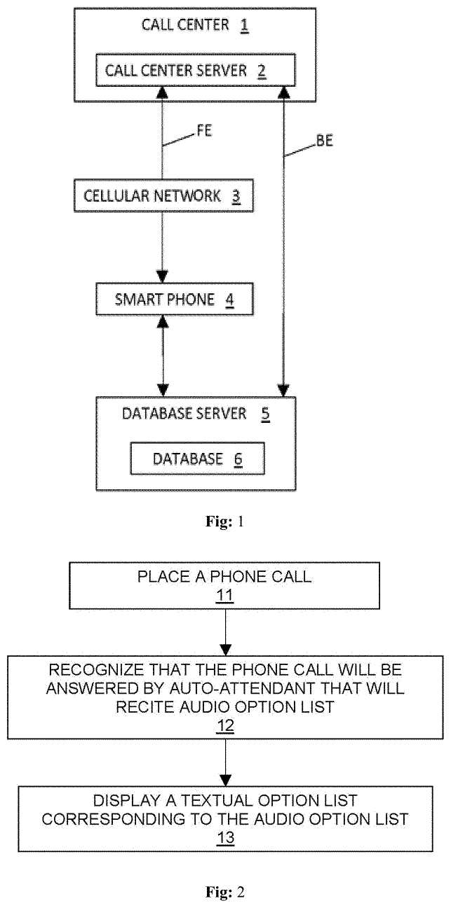

FIG. 2 is a flow chart of an example method performed by a system, for IVR or auto-attendant enhancement. A communication device of the system places a phone call. The system recognizes that the phone call will be answered by an IVR or auto-attendant that will recite an audio option list. The communication device displays a textual option list that corresponds to the audio options list.

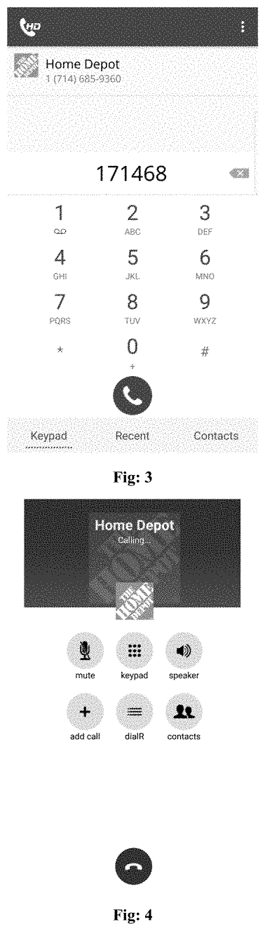

FIG. 3 is an exemplary embodiment where a phone call is placed to Home Depot®.

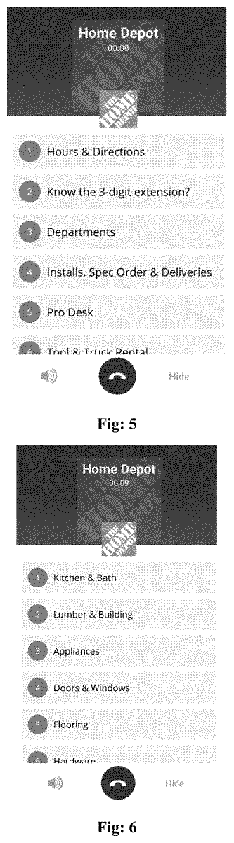

FIG. 4 shows connecting a phone call where the database recognizes the phone number called by the user and in turn, the database recognizes that the phone call will be answered by the auto-attendant that will recite audio options list.

FIG. 5 displays to the user via the app, a textual option list that is associated with the called phone number and corresponds to the call center's audio option list. The textual option list was retrieved by the database when the phone number was recognized, and sent by the database server to app for display to the user. In an exemplary situation where the auto attendant is currently saying, “Press 1 for Hours and directions; Press 2 if you know the 3-digit extension of the party you are trying to reach, etc.”

FIG. 6 shows displaying to the user via the app a textual option list retrieved by the database corresponding to the call center's audio option list where the user pushed “3 Departments.” The user's selection of “3 Departments” 1) sends a DTMF tone to the call center's server which prompts the auto attendant or IVR to recite the next menu list: “Press 1 for Kitchen and Bath; Press 2 for Lumber and Building, etc . . . ” and 2) simultaneously send the selection to the database, which then prompts the database server to send the corresponding textual option list to be displayed in the app for the user:

As explained above, data in the database includes each call center's phone number and may also include other data, like a restaurant's menu. This data might be obtained by a person (1) finding a tangible copy of the menu or finding a copy of the menu online, and then (2) manually entering the restaurant's menu into the database. The person might periodically (e.g., monthly) verify the restaurant's menu to check for any updates (changes) that the Restaurant might have made to the menu.

In another example, the database server and the Restaurant's server might be mutually configured (programmed) to communicate with each other through a back end communication channel BE (back channel). The back channel might be implemented through API (Application Programming Interface). In that case, at least some of the data (call center phone numbers and Menu) in the database might be obtained from the restaurant's server itself via the back channel. This obviates the need for the menu and subsequent menu updates to be manually recorded and entered into the database.

While the user is communicating with the agent of the restaurant, the restaurant's server can send, to the app for display on the phone's screen, text and visual media that is relevant to the user's interaction with the agent. For example, if the user is placing an order with the agent, the displayed relevant text might include pictures of menu items available for order, or the details of the user's order for verification purposes. And if the user is making a payment through the agent, the displayed relevant text might include a request for payment. The relevant text, displayed during interaction with the agent, can be communicated by the restaurant's server to the app through the front channel, in the form of signals that are embedded within the phone call but that are imperceptible to the user. Alternatively, the relevant text can be communicated by the restaurant server to the app through the back channel (via the database server).

The restaurant server may, via the front-end channel or the back channel (database server) sends a request for payment to the user, which is displayed in the interface of the app.

The user, through the app interface, may pay for goods or services while communicating with the call center agent during a live phone call. The user, for example, may pay for their order during communication with the restaurant over a live phone call. The user indicates the payment method and initiates the payment in the app, which is then sent the payment processing company through an encrypted channel. Once the payment is approved or denied by the payment processing company, the results are sent to the database. The database server then sends confirmation of payment approval (or denial) to be displayed in the app for the user, and/or to the restaurant's server to be displayed for the restaurant agent.

The user may also make a payment in the app that uses a payment processing company that may be mutually configured with the restaurant's server.

The user, through the app, may pay for goods or services by manually entering the method of payment and relevant information into the app interface. For example, the user may enter credit card numbers, expirations dates, and a billing address. The user may also store various methods of payment to the database to obviate the need to manually enter payment methods for each request for payment. The user may then pay for goods and services by selecting stored methods of payment already added to the database under the user's profile.

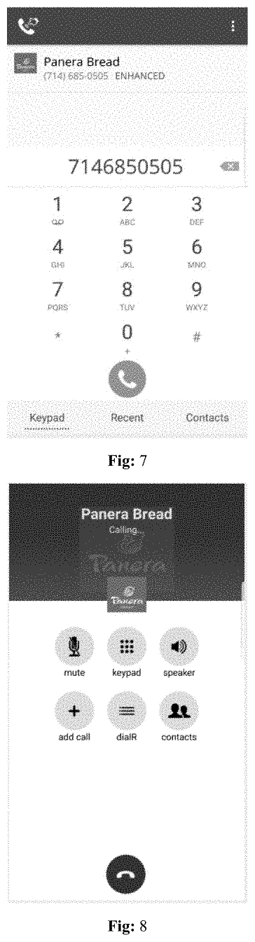

FIG. 7 shows user enters/finds phone number to the Panera Bread® restaurant.

FIG. 8 shows call, made using the app, is connecting to the Restaurant, where the database recognizes the phone number called by the user. The database also recognizes that the phone call may result in the user ordering menu items found in the database under said restaurant and phone number.

FIG. 9 shows call is answered by restaurant agent (human.) The user verbally tells the restaurant agent that he would like to order a “Medium Club” sandwich and the restaurant employee enters the menu item ordered into the restaurant's server. The restaurant server sends the menu item ordered “Medium Club” to the database, which is then sent by the database server to be displayed in the app on the phone screen for the user.

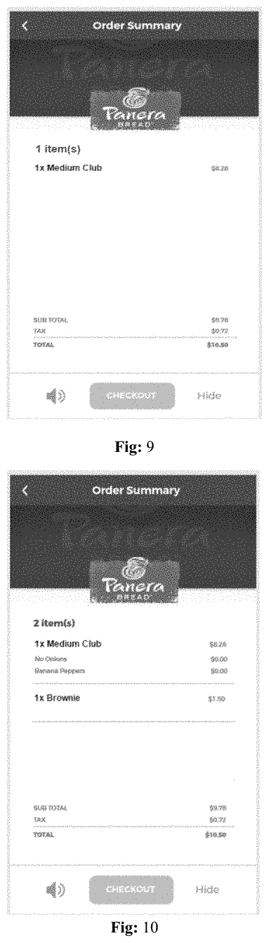

FIG. 10 shows the user verbally tells the restaurant agent employee (human) the rest of his order which might include a variety of items or modifications to items, such as “No Onions” on his Medium Club sandwich, add “Banana Peppers” to his Medium Club sandwich, and then he also ordered a “Brownie”. In each instance, and for each item or modification, the restaurant agent enters the menu item (or modification to the menu item) into the restaurant server, which sends the request to the database, which is then sent by the database server to be displayed in the app on the phone screen for the user.

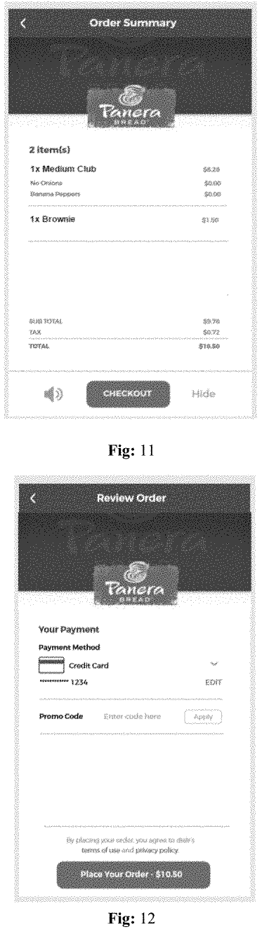

FIG. 11 shows the “Checkout” link at the bottom of the page has now lit up after the user has told the restaurant agent (human) that his order is correct and he is ready to pay for the order. In such case, the restaurant agent enters a request for payment into the restaurant server, which sends the request to the database, which is then sent by the database server to be displayed in the app on the phone screen for the user. The request for payment is displayed to the user in the form of an activated and lit up “Checkout” link. The user now clicks the “Checkout” link to go to the next page, where he can begin the process of satisfying the request for payment by entering a credit card manually or selecting a credit card already stored in the database under the user's account.

FIG. 12 shows the user pay for the order during a live phone call with the restaurant agent. The user, with the interface of the app, can choose a payment method already stored in the database or enter a manual payment method. The user can authorize the payment by clicking “Place Your Order” link, which sends the payment information through an encrypted channel to the payment processing company. The payment processing company in turn will send the approval or denial of the transaction to the database.

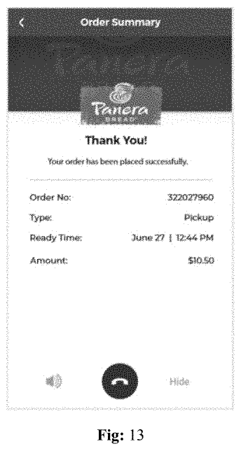

FIG. 13 shows the user sees that his payment is confirmed and the order has been paid for. The confirmation of payment, which was received by the database from the payment processing company, is sent by the database server to be displayed in the app on the phone screen for the user.

Examples of other call centers might been online retailer, hotel, government agency, a manufacturer, and a brick and mortar retailer.

Examples of the different agents might be sales, billing, customer service, and technical support. The agent might be non-human and computer-automated, for example where the user simply enters, by phone touchpad (keypad), personal account information. Alternatively, the agent might be a human that speaks with the user over the phone line, for example to resolve an issue that needs human interaction.

Examples of the placement of the phone call might be through the user dialing the call center's phone number using the smart phone's virtual keypad. Or by the user clicking on the call center's phone number that is displayed on a website the user is viewing on the smart phone.

The app might replace the phone's standard phone dial pad with the app's own custom dial pad or it can be outsourced so that any user may use the content of database to display visual content on their own native dialers.

While a specific embodiment has been shown and described, many variations are possible. With time, additional features may be employed. The particular shape or configuration of the platform or the interior configuration may be changed to suit the system or equipment with which it is used.

Having described the present disclosure in detail, those skilled in the art will appreciate that modifications may be made to the present disclosure without departing from its spirit. Therefore, it is not intended that the scope of the present disclosure be limited to the specific embodiment illustrated and described. Rather, it is intended that the scope of this present disclosure be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method, comprising:
a) placing, by a computing system, a phone call;
b) recognizing, by the computing system, that the phone call will be answered by a human that will converse with a user; and
c) displaying, on the computing system, digital media that corresponds to the nature of the conversation between the two people conversing

2. The method of claim 1, further comprising:
where the Interactive Voice Response IVR prompts callers to make numerical or voice selections corresponding to the department or person to which they want to be connected.

3. The method of claim 1, further comprising:
making payments during a phone call by either manual or saved payment methods.
